(19) United States
(12) Patent Application Publication
(10) Pub. No.: US 2003/0159075 A1
(43) Pub. Date: Aug. 21, 2003

(54) Information processing apparatus and device power control

(75) Inventor: Toshiya Miyazaki, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/284,260

(22) Filed: Oct. 31, 2002

(30) Foreign Application Priority Data
Feb. 15, 2002 (JP) 2002-037731

(51) Int. Cl. G06F 1/26

(52) U.S. Cl. 713/300

(57) ABSTRACT

An information processing apparatus such that power consumption at time of Internet access can be dramatically reduced, allowing battery-driven operating time to be extended as much as possible. An apparatus is provided with a communication functions unit capable of communicating with any web server; a device subject to control determination means for determining devices subject to control that are to be subject to power control based on input/output data transmitted between the communication functions unit and a web server; and a power control means to control power to devices subject to power control.

### BACKGROUND OF THE INVENTION

1. Field of Invention

The present invention relates to an information processing apparatus having an Internet communication functions unit that can access any web servers on the Internet to transmit data thereto and receive data therefrom, allowing a user to browse data content and receive services.

2. Related Technology

With the spread of the Internet, access to web servers using personal computers, personal digital assistants, cellular phones, and the like has been rapidly increasing. In particular, so-called mobile devices such as notebook computers, PDAs and cellular phones now allow access to the Internet from virtually any time at virtually any place; thus these devices are increasingly being used for accessing web servers via the Internet, as opposed to the uses for which they were originally designed.

Most of these mobile devices are battery driven, out of consideration for portability, and thus their operating time is limited by the capacity of their batteries. For this reason, research and development has focused on ways to reduce the power consumption of these mobile devices in order to lengthen operating time, and various methods have been proposed.

One approach is to constitute a mobile device by combining low energy consumption devices. Another is power management techniques, such as monitoring whether input devices such as a keyboard and a mouse are in use; when they have not been operated for a set period of time, the CPU clock slows down, the display is darkened, and the hard disk platters stop spinning. Methods such as these are used to control power adaptively, enabling battery-driven operating time to lengthen.

In the above-described power management techniques, the power statement of a device is changed depending on a user's actions with regards to a mouse or a keyboard. However, in cases where a user is browsing the data content on a web server, even if the user is not performing any operations, it is conceivable that a communications device or display device will require the power to be on; the opposite is also conceivable, that is, there may be devices for which there is no need for the power to be on, even while a user is in the midst of performing actions. Thus simply monitoring a user's actions may not lead to the appropriate power control; there is need for a more detailed power control, i.e., power control whereby power is supplied to the respective devices in an apparatus only when necessary, and power is turned off when it is not needed.

### SUMMARY OF THE INVENTION

It is an object of the present invention to present an information processing apparatus wherein power consumption during Internet access is greatly reduced, and battery-driven operating time is lengthened to the greatest extent possible.

An information processing apparatus comprises a plurality of devices for which the supplied electrical power can be controlled independently, a communication functions unit capable of communicating with any web server, a device subject to control determination means for determining which of the plurality of devices is to be a device subject to control that will be subject to power control, such determination to be based on input/output data transmitted between the communication functions unit and a web server, and power control means for controlling power to the device subject to control.

Here, a web browser is comprised that presents to a user data that the communication functions unit has acquired from a web server and sends data inputted by a user to a web server via the communication functions unit. The device subject to control determination means comprises a proxy server that relays between the communication functions unit and the web browser input/output data transmitted between the communication functions unit and a web server.

A web browser is comprised that presents to a user data that the communication functions unit has acquired from a web server and sends data inputted by a user to a web server via the communication functions unit. The device subject to control determination means is a plug-in module for the web browser that dynamically couples with the communication functions unit.

A profile reference means for referencing the device profile of corresponding devices is comprised further., The device subject to control means determines a device subject to power control based on a device profile referenced by the profile reference means.

The device subject to control determination means comprises a reserved word database for managing keywords relating to devices subject to power control, and determines which device is to be subject to control based on a keyword in the reserved word database and input/output data transmitted between the communication functions unit and a web server.

A status information acquisition means for acquiring information on device use status, information on status of data display on the web browser, and information on user status is comprised further. The device subject to control means determines which device is to be subject to power control based on the status information acquired by the status information acquisition means.

Further, a control information addition means for adding to the data displayed by the web browser power control information to the effect that the power control means is conducting power control is comprised.

From the following detailed description in conjunction with the accompanying drawings, the foregoing and other objects, features, aspects and advantages of the present invention will become readily apparent to those skilled in the art.

### BRIEF DESCRIPTION OF THE DRAWINGS

FIG. 1 is a function block diagram showing the constitution of a first embodiment of the present invention.

FIG. 2 is a function block diagram showing the constitution of another embodiment of the present invention.

FIG. 3 is a block diagram showing hardware constitution.

FIG. 4 is a drawing for explaining an HTML document.

FIG. 5 is a drawing for showing power control processing at time of content display.

FIG. 6 is a flowchart of determination for devices subject to power control.

FIG. 7 is a flowchart of determination for devices subject to power control.

FIG. 8 is a flowchart of power control information display.

FIG. 9 is a drawing for explaining the power control information display screen.

FIG. 10 is a flowchart of incremental power control processing.

FIG. 11 is a time chart of incremental power control processing.

### DESCRIPTION OF THE PREFERRED EMBODIMENTS

### Outline of the Constitution

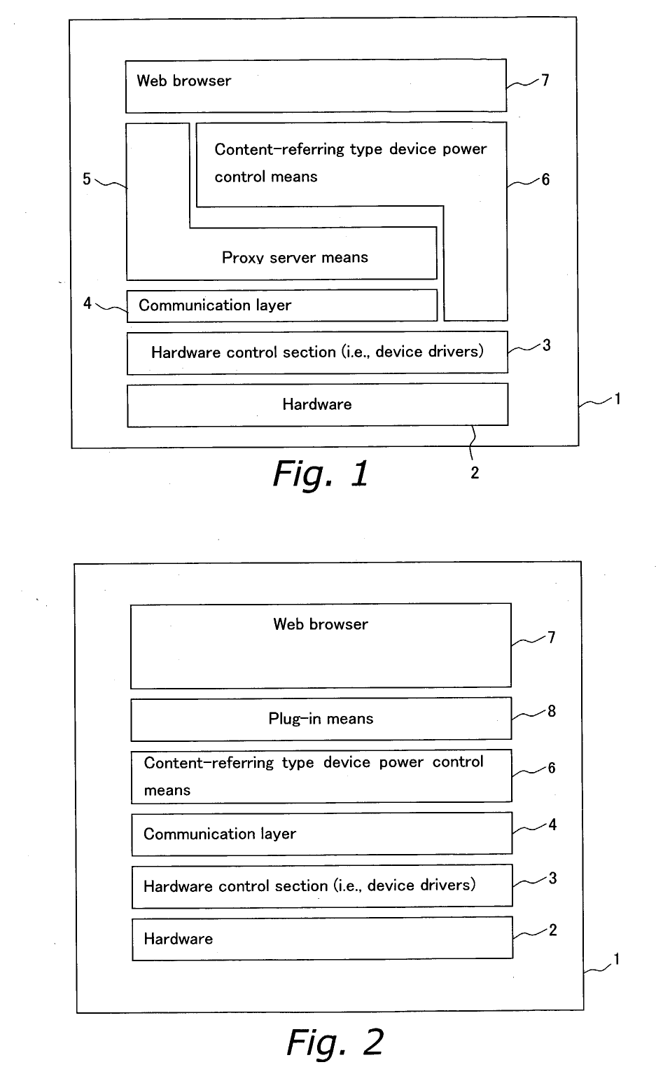

FIGS. 1 and 2 show an outline of the constitution of an information processing apparatus in which a first embodiment of the present invention has been adopted.

The constitution shown in FIG. 1 is of an apparatus that includes a proxy server, and the constitution shown in FIG. 2 is of an apparatus that includes a plug-in.

In FIG. 1, an information processing apparatus 1 includes a hardware section 2, a hardware control section 3, a communication layer 4, a proxy server 5, power control means 6, and a web browser 7.

The hardware section 2 includes such devices as a hard disk drive, an IDE device such as a CD-ROM drive, a flexible disk drive, a LAN connection unit, a liquid crystal display, a backlight, speakers, and 3D chips.

The hardware control section 3 comprises device drivers for controlling the various devices in the hardware section 2, including IDE controllers such as an HDD controller and CD-ROM controller, a LAN controller, a video controller for display control of the liquid crystal display, and a sound controller for controlling the sound produced by speakers.

The communication layer 4 is a layer for transmission/reception of data through access of the Internet using the hardware section 2 and the hardware control section 3, and includes protocols such as TCP-IP.

The web browser 7 is a client for providing a user with data received from a web server over the Internet; according to data content, it will control devices in the hardware section 2 and the device control section 3 to cause the display of images or the reproduction of sound.

The proxy server 5 relays data that the web browser 7 has sent to or received from a web server, and is compatible with such protocols as, for example, HTTP, FTP, SMTP, and POP; usually, a proxy server that is compatible with HTTP is used, in order to acquire content that the web browser 7 has requested from a web server. The proxy server 5 also transmits the data sent out from the web browser through the communication layer 4. The proxy server 5 can function as a cache, temporarily storing content received from a web server, and, when the web browser 7 has requested that content, displaying the stored content. The proxy server 5 can also have a filtering function, controlling the viewing of specific content registered in advance, limiting external access, and such. In addition, in this embodiment, the proxy server 5 causes power control means 6 to execute power control in accordance with received data.

The power control means 6 acquires from the proxy server 5 such data as data relating to type of received data and data relating to data display, determines the device subject to control that will be subject to power control, and causes execution of power control using the hardware control section 3 and the web browser 7. The power control means 6 may be integrally constituted with the proxy server 5.

The information processing apparatus 1 includes a CPU, a memory, a data bus and the like; the web browser 7, the power control means 6, the proxy server 5, the communication layer 4, the hardware control section 3 and the like are constructed from software.

In the information processing apparatus 1 shown in FIG. 2, a plug-in means 8 is used in place of the proxy server 5. This plug-in means 8 dynamically links with the web browser 7 using an interface provided by the web browser 7, operating as a sub-routine of the web browser 7. In these cases, too, the power control means 6 may be integrally constituted with the plug-in means 8.

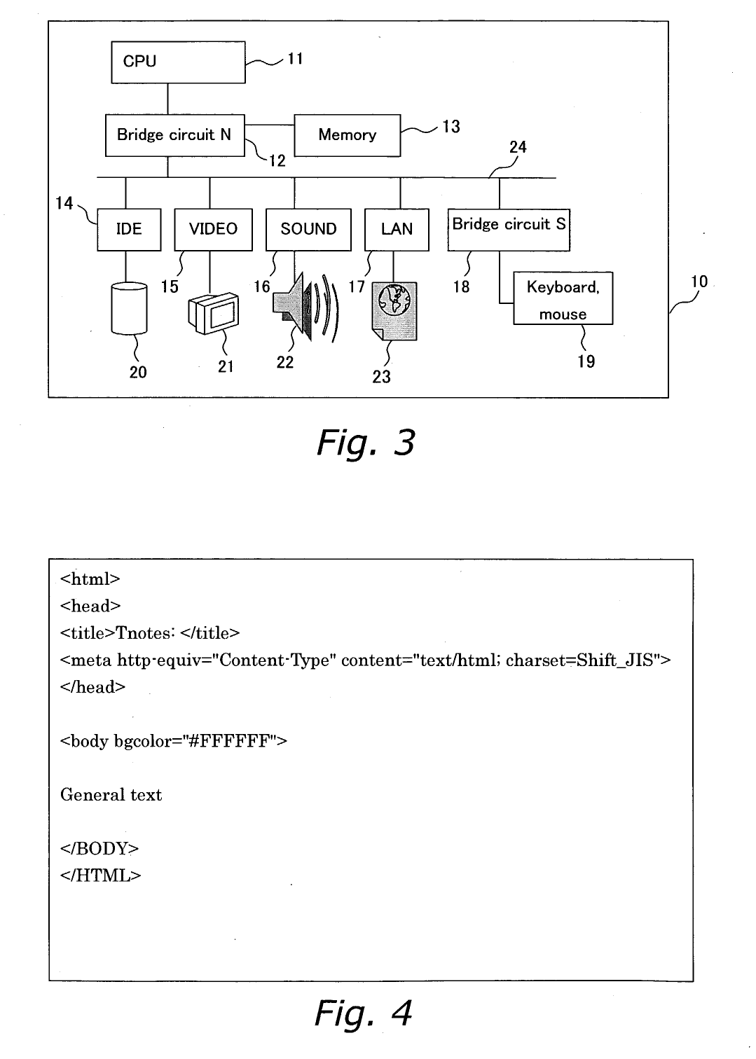

FIG. 3 shows a standard personal computer (PC) as an example of a constitution of such the information processing apparatus 1. This PC 10, which is an information processing apparatus capable of accessing the Internet, comprises a CPU 11, a bus 24 and a memory 13, which are connected by a bridge circuit 12.

The following elements are connected by the bus 24: an IDE device controller 14 that controls a hard disk 20, a video controller 15 that controls a display 21, a sound controller 16 that controls a speaker 22, a LAN controller 17, and the like. Connected to the LAN controller 17 is a LAN device 23 for, for example, a wired 10Base-T or 100Base-TX LAN or an IEEE 802.11b compatible wireless LAN. The assorted devices are connected if necessary, and unnecessary devices do not have to be connected.

With this kind of hardware constitution, the web browser 7 as described above is loaded, allowing the browsing of a variety of content on the Internet.

### Power Control during Browsing

The standard markup languages used at web servers for content are such languages as XML and HTML; the web browser 7 on the PC 10 is also compatible with XML and HTML, allowing a user to browse the contents of web sites.

FIG. 4 shows an example of web page content written in HTML. In the HTML document shown in FIG. 4, the section from <html> to </HTML> comprises one page of content. When such an HTML document is displayed by a standard web browser, assuming that the browser does not have a pre-read function, at the stage when the user is finished reading this one page, network access is unnecessary until the user takes his/her next action.

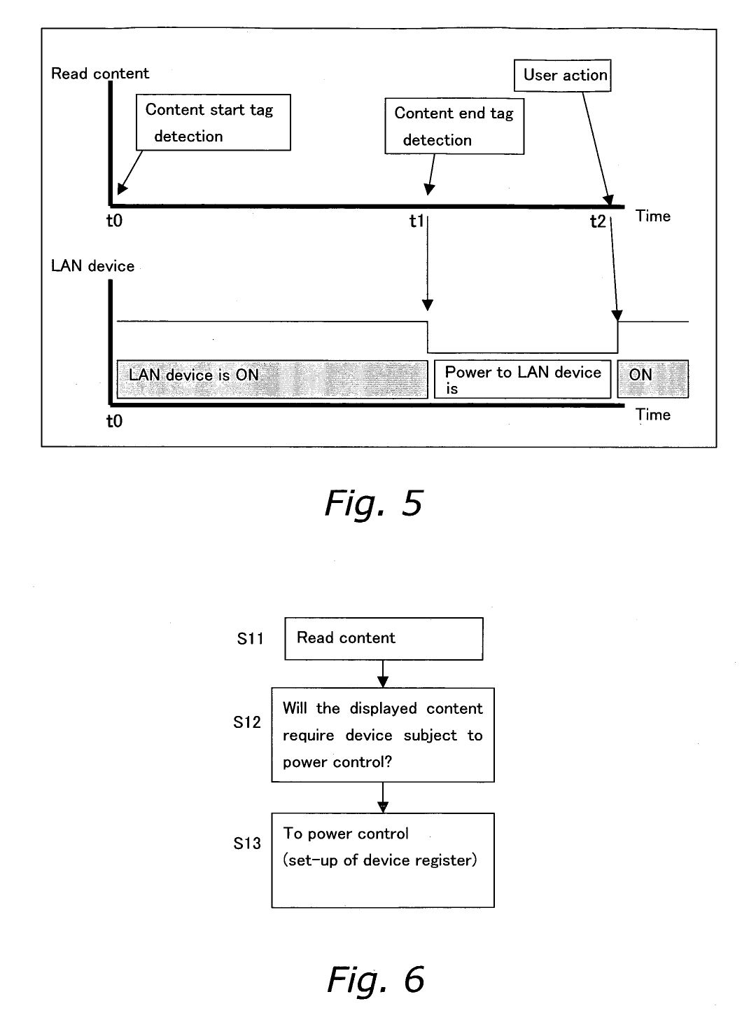

In constitutions that have the proxy server 5 as shown in FIG. 1, content acquired from the Internet through the communication layer 4 is either temporarily stored by the cache function of the proxy server 5 or is transmitted directly to the web browser 7. When an HTML document as shown in FIG. 4 is sent from the proxy server 5 to the web browser 7, for the period from the time the web browser 7 detects the start HTML tag <html> until the time it detects the end HTML tag </html>, that is, for the period of time t0 to t1, the LAN device 23 is ON, and data is read from the proxy server 5 (see FIG. 5). The web browser 7, after detecting the end HTML tag </html>, displays the text contained in this HTML document on the display 21. In cases where sound output, image data and video data are included, the content is presented to the user using the sound controller 16 and the graphic engine and the like.

During time t1 to t2, which is the time between detection of the end HTML tag </html> until the user's next action, the web browser 7 does not need to read the content, but simply must maintain the status of presenting to the user content it has already read. Therefore, during this time t1 to t2, the power control means 6 sets the LAN device 23 to OFF. The power control means 6 does this by outputting a power OFF instruction to the LAN controller 17 in the hardware control section 3, causing the power of the LAN device 23 to be turned OFF.

If, for example, the user takes some kind of action at time t2, the power of the LAN device 23 is turned ON, the next content is read, or data inputted by the user is transmitted.

In cases of HTML documents as the one above, containing only text, by turning OFF the power to the sound device that outputs sound, the graphic engine and the like, energy consumption can be further reduced.

### Device Power Control

In cases of a constitution including the proxy server 5 as shown in FIG. 1, a web server on the Internet is accessed using communication means in the hardware section 2, and the web server content acquired through the communication layer 4 is sent to the web browser 7. Data transmission from the web browser 7 is performed along this route but in reverse. In this process, the proxy server 5 receives the data from the communication layer 4 before it reaches the web browser 7, and it receives data transmitted from the web browser 7 before it reaches the communication layer 4.

Standard proxy servers are compatible with HTTP and FTP as defined in TCP/IP, and they transmit and receive data to and from web servers at a stage before a web browser becomes involved. Depending on how a proxy server is set up, it can pass along content received from a web server unchanged to the web browser, or it can pass content to the web browser after processing it in a manner required by the content.

By configuring the proxy server 5 out of software, the proxy server 5 can be given flexibility; in such cases, it will comprise a single process that operates independently of the web browser 7. In addition, because standard web browsers and application software using TCP/IP include a function for designating a proxy server, by setting the web browser 7 to use the proxy server 5, a user can make use of the proxy server 5.

In cases of a constitution having the plug-in means 8, as shown in FIG. 2, by using an interface provided by the web browser 7, which has been prepared in advance, the plug-in means 8 functions as a sub-routine dynamically linked to the web browser 7 and can essentially operate as the same process as the web browser 7. Thus less CPU power is used in comparison to when the proxy server 5 is used.

Device power control operations using the power control means 6 will be explained with reference to FIG. 6.

First, content is read (step S11). In this case, content acquired from the Internet through the communication layer 4 is read.

Next, a determination is made as to whether the read content will use a device subject to power control (step S12). The determination of whether a device is a device subject to power control can be performed either by referring to device profiles set up in advance in the PC 10, and setting devices that will not be used because of the nature of the read contents as devices subject to power control, or by using the determination processing described below.

Power control is then implemented for devices determined in step S12 to be devices that will not be used (step S13). For example, the register that manages power ON/OFF flags for devices is instructed to set the flags for devices subject to power control to OFF.

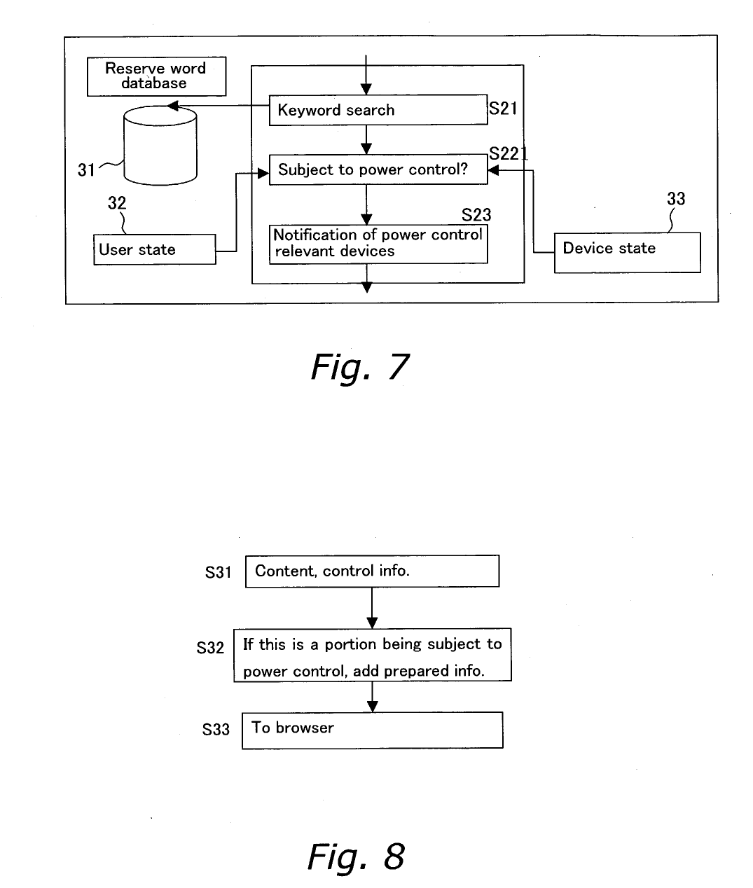

With reference made to FIG. 7, an explanation will now be made of an example of device subject to power control determination processing in step S12.

The PC 10 includes a reserve word database 31, which has been prepared in advance. Registered in the reserve word database 31 as reserve words are character strings associated with device control, indicating that when predetermined character strings are included in the character strings in a document, the relevant device is needed to display the content. For example, for graphics-related devices, video file identifiers such as “.mpg”, “.avi”, and “.mov” are registered as reserve words, and for sound-related devices, audio data file identifiers such as “.mp3” and “.wav” are registered as reserve words. In addition, by registering identifiers relating to CPU power, such as “.class”, and identifiers relating to Java applications, such as “.java”, power control can be implemented with regards to the CPU power and devices that work with Java applications and Java applets.

The character strings of read content are searched and determination is made whether or not reserve words registered in the reserve word database 31 are present (step S21). In cases where the content contains no reserve words reserved for certain devices, those devices are selected as potential devices to be subject to power control.

Determination is then made whether the devices selected as potential devices to be subject to power control should be subject to power control (step S22). This is done by determining whether a device should be subject to power control based on user state, acquired by the user state acquisition means 32, and device state, acquired by the device state acquisition means 33.

The user state acquisition means 32 is means for acquiring information relating to user activity, such as a user's moving a pointing device, screen scrolling, user's presence/absence; it can acquire this kind of information by receiving event notification from the operating system. Therefore, in cases where it is determined based on user state acquired by the user state acquisition means 32 that there is a device that the user is using, the power control means 6 excludes that device from devices subject to power control.

The device state acquisition means 33 is means for acquiring information relating to device state, that is, whether or not devices are currently being used in other processes; it is constituted to acquire this information from the states of processes being maintained by the operating system. For example, in a case where music is being played by another process, the device state acquisition means 33 acquires device state information to the effect that the sound device is currently in use; based on this information, the power control means 6 excludes that sound device from devices subject to power control.

Next, power control notification is made for devices subject to power control (step S23). As discussed above, a register that manages the power ON/OFF flags for devices is instructed to set the flags for the devices subject to power control to OFF.

### Display of Power Control State

The web browser 7 or the proxy server 5, integrally provided with the plug-in means 8, can be constituted to cause information about the power control currently being implemented to be displayed on the web browser screen; the processing in such a case is shown in FIG. 8.

First, content is read and information for devices to be subject to power control processing is acquired (step S31). Specifically, content made up of an HTML document and the like is read and information on devices subject to control generated by the power control means 6 is acquired.

Next, when power control is being implemented, predetermined information is added to the content (step S32). For example, a special tag for HTML documents is prepared in advance in the web browser 7; by attaching to the content a tag for an attribute or element indicating current power control information, power control information can be displayed on the browser screen.

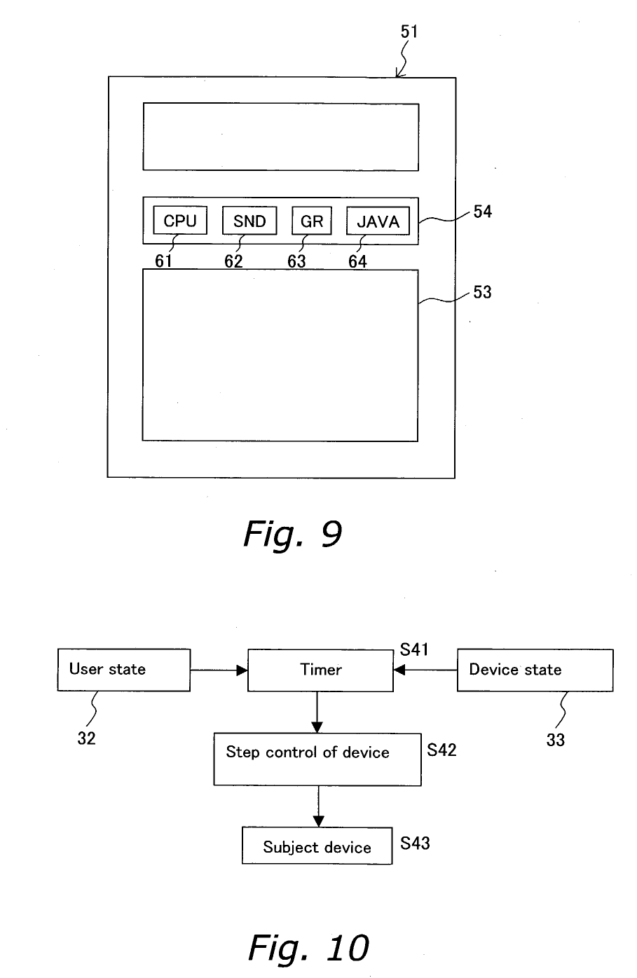

For example, as shown in FIG. 9, when a content display section 53 is included on a browser screen 51, the read content is displayed on this content display section 53. The browser screen 51 can be constituted to further include a power control information display section 54, and this power control information display section 54 displays current power control information. For example, the power control information display section 54 comprises a CPU power display section 61, a sound device state display section 62, a graphic device state display section 63, a Java-related device state display section 64 and the like; these can be constituted to display black for devices that are ON, and gray for devices that are OFF, or they can be constituted so that either ON or OFF are displayed as words. In addition, for CPU power and other devices for which incremental power control is possible, the various power stages can be displayed by color, such as green, yellow, red, etc. in high order of power.

### Power Control Using User State

When a user is not in front of a device, the screen display and sound function can be controlled. Power control in such cases will now be explained with reference made to FIG. 10.

First, based on user state acquired by the user state acquisition means 32 and device state acquired by the device state acquisition means 33, determination is made of whether a predetermined status has continued for a set period of time (step S41). For example, in a status such that based on event notification received from the operating system, it is detected that a user is not present (in cases, for example, where a state of no input from a pointing device and the like has continued), and the speaker 22 has continued to output sound, when a timer count has exceeded a predetermined value, control proceeds to step S42.

A power value for performing incremental device power control is set (step S42). For example, when the device state information acquired by the device state acquisition means 33 includes information to the effect that output by the sound controller 16 to the speaker 22 is V, volume is set at V*a, where 0<a<100%.

Next, based on the set power value, power control is carried out with regard to the device subject to power control (step S43).

Thereafter, when the same status continues unchanged, steps S41 to S43 are repeated, and incremental power control is implemented.

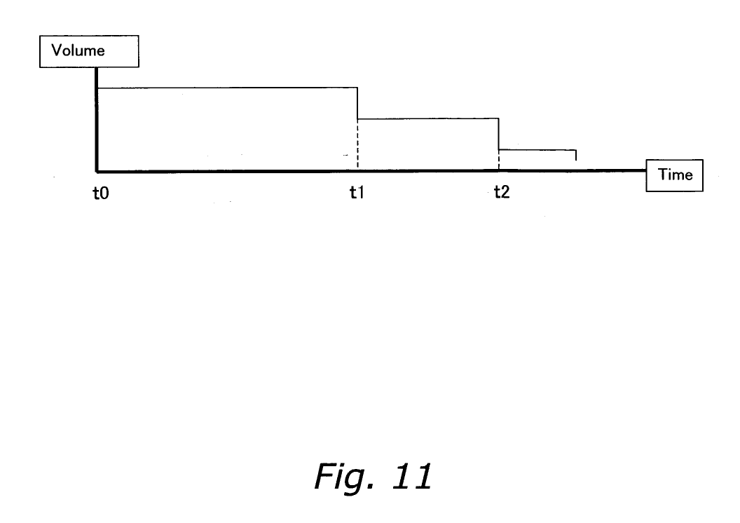

In cases where a user is not at the device and sound continues to be output, each time a predetermined amount of time has passed, the volume is progressively lowered; this power control is illustrated by FIG. 11. Specifically, when a condition such that a user is not at a device and sound has continued to be output has continued, after the elapse of time t1, volume is reduced to a %, and after the further elapse of time t2, volume is again reduced to a %.

In cases where the display 21 is a liquid crystal display and includes a backlight, a constitution is possible whereby the brightness of the backlight is reduced incrementally to control power, in a similar manner.

### OTHER EMBODIMENTS

The determination of whether devices are to be used or not can be made by referring to device profiles set up in advance in the PC 10 and determining that devices that will not be used based on compatibility with read contents will be devices subject to power control. In addition, determination of devices subject to control using device profiles and determination of devices subject to control as described above can be used in combination.

A local machine such as the PC 10 having a proxy server loaded therein was described above, but a proxy server connected through the LAN device 23 can also perform power control.

The present invention allows a constitution whereby power control is performed depending upon the content being viewed by a web browser, fine-tuned power control of devices is possible, and the operating time for battery-driven devices can be extended dramatically.

Only selected embodiments have been chosen to illustrate the present invention. To those skilled in the art, however, it will be apparent from the foregoing disclosure that various changes and modifications can be made herein without departing from the scope of the invention as defined in the appended claims. Furthermore, the foregoing description of the embodiments according to the present invention is provided for illustration only, and not for limiting the invention as defined by the appended claims and their equivalents.

What is claimed is:

1. An information processing apparatus comprising: a plurality of devices for which the supplied electrical power can be controlled independently;
a communication functions unit capable of communicating with any web server;
a device subject to control determination means for determining which of said plurality of devices is to be a device subject to control that will be subject to power control, such determination to be based on input/output data transmitted between said communication functions unit and a web server; and
a power control means for controlling power to said device subject to control.

2. An information processing apparatus in accordance with claim 1, comprising a web browser that presents to a user data that said communication functions unit has acquired from a web server and sends data inputted by a user to a web server via the communication functions unit,
wherein:
said device subject to control determination means comprises a proxy server that relays between said communication functions unit and said web browser input/output data transmitted between said communication functions unit and a web server.

3. An information processing apparatus in accordance with claim 1, comprising a web browser that presents to a user data that said communication functions unit has acquired from a web server and sends data inputted by a user to a web server via the communication functions unit,
wherein:
said device subject to control determination means is a plug-in module for said web browser that dynamically couples with said communication functions unit.

4. An information processing apparatus according to claim 1, further comprising a profile reference means for referencing the device profile of corresponding devices, wherein said device subject to control means determines a device subject to power control based on a device profile referenced by said profile reference means.

5. An information processing apparatus according to claim 1, wherein said device subject to control determination means comprises a reserved word database for managing keywords relating to devices subject to power control, and determines which device is to be subject to control based on a keyword in said reserved word database and input/output data transmitted between said communication functions unit and a web server.

6. An information processing apparatus of claim 2, further comprising a status information acquisition means for acquiring information on device use status, information on status of data display on said web browser, and information on user status, wherein said device subject to control means determines which device is to be subject to power control based on the status information acquired by said status information acquisition means.

7. An information processing apparatus of claim 6, further comprising a control information addition means for adding to the data displayed by said web browser power control information to the effect that said power control means is conducting power control.
